(19) United States
(12) Patent Application Publication
(10) Pub. No.: US 2019/0196262 A1
(43) Pub. Date: Jun. 27, 2019

(54) DISPLAY APPARATUS INCLUDING HEAT DISSIPATING PART

(71) Applicant: SAMSUNG DISPLAY CO., LTD., Yongin-si (KR)

(72) Inventors: Byoungjin Jin, Yongin-si (KR); Dongjin Park, Gwangmyeong-si (KR); Jinhyuk Park, Hwaseong-si (KR); Jingyu Sim, Suwon-si (KR); Junggil Oh, Hwaseong-si (KR); Kwangsun You, Cheonan-si (KR); Won-Chui Lee, Seoul (KR); Jonghyeon Choi, Pyeongtaek-si (KR)

(21) Appl. No.: 16/220,055

(22) Filed: Dec. 14, 2018

(30) Foreign Application Priority Data
Dec. 27, 2017 (KR) 10-2017-0181474

(51) Int. Cl. G02F 1/1335; F21V 8/00

(52) U.S. Cl. CPC G02F 1/133524; G02B 6/0085; G02B 6/0073; G02F 1/133615

(57) ABSTRACT

A display apparatus includes a display panel and a light guiding plate disposed under the display panel, and including a light exiting surface and a light incidence surface. The display apparatus further includes a first adhesive member disposed between the display panel and the light guiding plate. The display apparatus additionally includes a heat dissipating part disposed under the display panel, and including a first portion extending parallel with the display panel, a second portion extending from the first portion in a direction perpendicular to the first portion, and a third portion extending from the second portion and parallel with the first portion. The heat dissipating part faces the light incidence surface. The display apparatus further includes a second adhesive member disposed between the display panel and the first portion of the heat dissipating part, and a first light source part disposed in the heat dissipating part.

### CROSS-REFERENCE TO RELATED APPLICATION

The present application claims priority under 35 U.S.C. § 119 to Korean Patent Application No. 10-2017-0181474, filed on Dec. 27, 2017, the disclosure of which is incorporated by reference herein in its entirety.

### TECHNICAL FIELD

Exemplary embodiments of the present inventive concept relate to a display apparatus. More particularly, exemplary embodiments of the present inventive concept relate to a display apparatus including a heat dissipating part.

### DISCUSSION OF THE RELATED ART

Display apparatuses having a relatively light weight and small size have been under development. A cathode ray tube (CRT) display apparatus had been widely used due to a performance and a competitive price. However, the CRT display apparatus is heavy and is not portable. Therefore, a display apparatus such as a plasma display apparatus, a liquid crystal display apparatus and an organic light emitting display apparatus have become more popular.

In the liquid crystal display apparatus, a voltage is applied to liquid crystal molecules to change an arrangement of the liquid crystal molecules. The liquid crystal display apparatus displays an image due to changes of optical properties (for example, birefringence, rotatory polarization, dichroism and light scattering) of a liquid crystal cell according to the changes of the arrangement of the liquid crystal molecules.

### SUMMARY

According to an exemplary embodiment of the present inventive concept, a display apparatus includes a display panel and a light guiding plate disposed under the display panel, and including a light exiting surface and a light incidence surface. The light exiting surface faces the display panel. The display apparatus further includes a first adhesive member disposed between the display panel and the light guiding plate. The display apparatus additionally includes a heat dissipating part disposed under the display panel, and including a first portion extending parallel with the display panel, a second portion extending from the first portion in a direction perpendicular to the first portion, and a third portion extending from the second portion and parallel with the first portion. The heat dissipating part faces the light incidence surface. The display apparatus further includes a second adhesive member disposed between the display panel and the first portion of the heat dissipating part, and a first light source part disposed in the heat dissipating part and configured to provide light to the light incidence surface of the light guiding plate.

In an exemplary embodiment of the present inventive concept, the display apparatus further includes a substrate. The first light source part is mounted on the substrate. The display apparatus additionally includes a third adhesive member disposed between the substrate and the second portion of the heat dissipating part.

In an exemplary embodiment of the present inventive concept, the substrate is spaced apart from the first portion, and makes contact with the third portion.

In an exemplary embodiment of the present inventive concept, the first light source part includes a light-emitting diode (LED) and a mold disposed on the substrate. The LED is disposed on the mold.

In an exemplary embodiment of the present inventive concept, the substrate extends parallel to the first portion, and the display apparatus further includes a second light source part disposed on the substrate.

In an exemplary embodiment of the present inventive concept, the light guiding plate is adjacent to the heat dissipating part.

In an exemplary embodiment of the present inventive concept, the first adhesive member is disposed along an edge of the light exiting surface of the light guiding plate, and the light exiting surface of the light guiding plate, a lower surface of the display panel and the first adhesive member form a receiving space.

In an exemplary embodiment of the present inventive concept, the receiving space is sealed by the first adhesive member.

In an exemplary embodiment of the present inventive concept, the display apparatus further includes an optical sheet disposed in the receiving space.

In an exemplary embodiment of the present inventive concept, the optical sheet includes a quantum dot (QD) sheet.

In an exemplary embodiment of the present inventive concept, a quantum dot (QD) layer is disposed on an upper surface of the light guiding plate.

In an exemplary embodiment of the present inventive concept, the first adhesive member includes a foam tape having adhesive layers formed on both surfaces thereof.

In an exemplary embodiment of the present inventive concept, the heat dissipating part includes aluminum or graphite.

In an exemplary embodiment of the present inventive concept, an opening is formed in the second portion.

In an exemplary embodiment of the present inventive concept, an opening is formed in the third portion.

In an exemplary embodiment of the present inventive concept, an opening is formed in the first portion.

In an exemplary embodiment of the present inventive concept, the second adhesive member is a double-sided tape.

According to an exemplary embodiment of the present inventive concept, a display apparatus includes a display panel and a light guiding plate disposed on the display panel, and including a light exiting surface facing the display panel and a light incidence surface. The display apparatus further includes a first adhesive member disposed between the display panel and the light guiding plate, and a heat dissipating part disposed on the display panel. The display apparatus additionally includes a second adhesive member disposed between the display panel and a first portion of the heat dissipating part, and a substrate disposed on the heat dissipating part. The display apparatus further includes a light source part disposed on the substrate and configured to provide light to the light incidence surface of the light guiding plate, and a third adhesive member disposed between the light source part substrate and the heat dissipating part.

According to an exemplary embodiment of the present inventive concept, a display apparatus includes a display panel, and a light guiding plate disposed on the display panel, the light guiding plate including a light exiting surface, which faces the display panel, and a light incidence surface, which faces away from the display panel. The display apparatus further includes a heat dissipating part disposed under the display panel, and including a first portion parallel to the display panel, a second portion extending from the first portion in a direction perpendicular to the first portion, and a third portion extending from the second portion and parallel to the first portion. The heat dissipating part faces the light incidence surface, and at least one of the first portion, second portion or third portion includes a plurality of openings. The display apparatus additionally includes a first light source part disposed in the heat dissipating part and configured to provide light to the light incidence surface of the light guiding plate.

In an exemplary embodiment of the present inventive concept, the second portion includes the plurality of openings.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawing, wherein:

FIG. 1 is an exploded perspective view illustrating a display apparatus according to an exemplary embodiment of the present inventive concept;

FIG. 2 is a cross-sectional view illustrating the display apparatus of FIG. 1 according to an exemplary embodiment of the present inventive concept;

FIG. 3 is a perspective view illustrating a heat dissipating part of a display apparatus according to an exemplary embodiment of the present inventive concept;

FIG. 4 is a cross-sectional view illustrating the display apparatus of FIG. 3 according to an exemplary embodiment of the present inventive concept;

FIG. 5 is a perspective view illustrating a heat dissipating part of a display apparatus according to an exemplary embodiment of the present inventive concept;

FIG. 6 is a cross-sectional view illustrating the display apparatus of FIG. 5 according to an exemplary embodiment of the present inventive concept;

FIG. 7 is a perspective view illustrating a heat dissipating part of a display apparatus according to an exemplary embodiment of the present inventive concept; and

FIG. 8 is a cross-sectional view illustrating the display apparatus of FIG. 7 according to an exemplary embodiment of the present inventive concept.

### DETAILED DESCRIPTION OF THE EMBODIMENTS

Exemplary embodiments of the present inventive concept will be described more fully hereinafter with reference to the accompanying drawings.

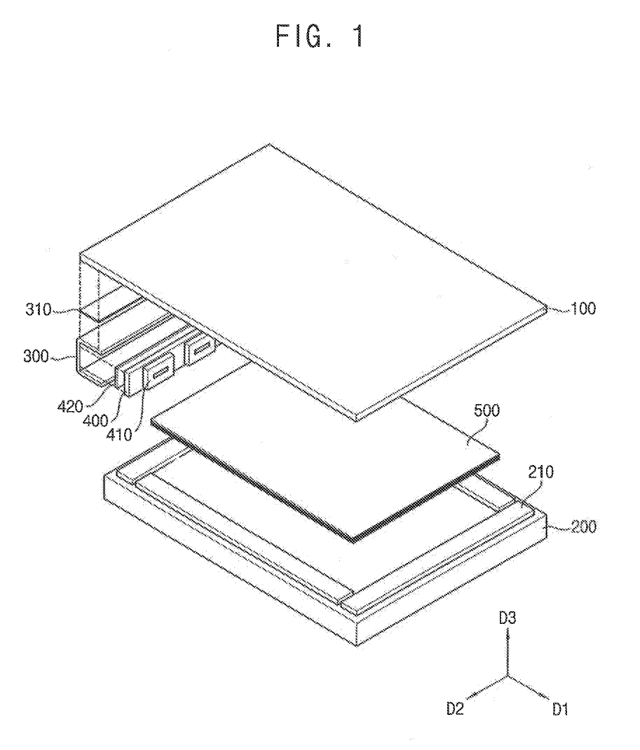

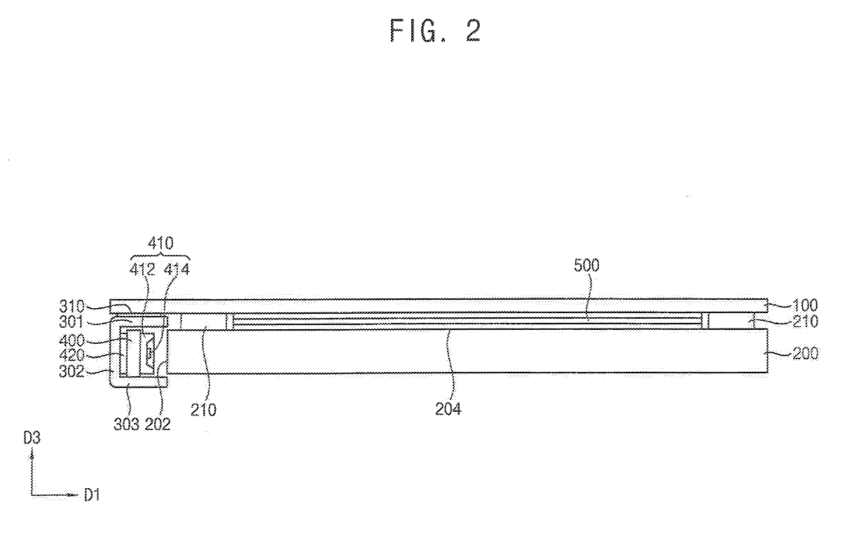

FIG. 1 is an exploded perspective view illustrating a display apparatus according to an exemplary embodiment of the present inventive concept. FIG. 2 is a cross-sectional view illustrating the display apparatus of FIG. 1 according to an exemplary embodiment of the present inventive concept.

Referring to FIG. 1, the display apparatus may include a display panel 100, a light guiding plate 200, a light guiding plate adhesive member 210, a heat dissipating part 300, a heat dissipating part adhesive member 310, a light source part substrate 400, a light source part 410, a light source part adhesive member 420, and an optical sheet 500.

The display panel 100 may be arranged in parallel with a plane which is formed by a first direction D1 and a second direction D2 which is perpendicular to the first direction D1. The display panel 100 may display an image using light from the light source part 410 according to a driving signal and a data signal applied from an external device. The display panel 100 may include an array substrate, an opposite substrate facing the array substrate, and a liquid crystal layer disposed between the array substrate and the opposite substrate.

The array substrate may include a plurality of gate lines, a plurality of data lines crossing the gate lines, and a plurality of switching element connected to the gate and data lines. The opposite substrate may include a black matrix blocking light and a color filter having a color. Although the opposite substrate includes the color filter in the present exemplary embodiment of the present inventive concept, the color filter may be formed in the array substrate. The liquid crystal layer may be disposed between the array substrate and the opposite substrate. The liquid crystal layer may include liquid crystal molecules that are optically anisotropic. The liquid crystal molecules may be driven by an electric field, and light may pass through or may be blocked by the liquid crystal layer to display an image. The display apparatus may further include an upper polarizing plate disposed on the display panel 100 and a lower polarizing plate disposed under the display panel 100.

The light guiding plate 200 may be disposed under the display panel 100. The light guiding plate 200 may be disposed adjacent to the heat dissipating part 300 in the first direction D1, and may guide the light generated from the light source part 410 toward the display panel 100. For example, the light guiding plate 200 may change a path of the light generated from the light source part 410 by guiding the light generated from the light source part 410 toward the display panel 100. The light guiding plate 200 may include a light incidence surface 202 facing the light source part 410, and a light exiting surface 204 facing the display panel 100.

Although the light guiding plate 200 has a uniform thickness in an exemplary embodiment of the present inventive concept, the light guiding plate 200 may have various shapes and/or a thickness that varies. For example, the light guiding plate 200 may have a wedge-shaped cross-section in which a thickness becomes thinner as a distance from the light source part 410 increases.

The light guiding plate 200 may be adhered to a lower surface of the display panel 100 by the light guiding plate adhesive member 210. For example, the light guiding plate adhesive member 210 may be a double-sided tape such as a foam tape having adhesive layers formed on both surfaces thereof. For example, the light guiding plate adhesive member 210 may include a first adhesive layer adhered to the display panel 100, a second adhesive layer adhered to the light guiding plate 200, and a foam layer between the first adhesive layer and the second adhesive layer. However, the present inventive concept is not limited thereto.

Although the light guiding plate adhesive member 210 is described as being adhered to the display panel 100 and the light guiding plate 200 in an exemplary embodiment of the present inventive concept, the light guiding plate adhesive member 210 may have a pressure sensitive adhesive property instead of the adhesive property. For example, the light guiding plate adhesive member 210 may be a pressure sensitive adhesive member.

In addition, in an example embodiment of the present inventive concept, the light guiding plate adhesive member 210 may be a layer including, for example, adhesive silicone, urethane or the like.

The light guiding plate adhesive member 210 may be disposed along an edge of the light exiting surface 204 of the light guiding plate 200, and the light exiting surface 204 of the light guiding plate 200, the lower surface of the display panel 100 and the light guiding plate adhesive member 210 may form a receiving space. For example, the display panel 100 is disposed on the light guiding plate adhesive member 210, and the receiving space is formed between the display panel 100 and the light exiting surface 204.

The receiving space may be sealed to the outside by the light guiding plate adhesive member 210. As a result, elements and/or components (for example, the optical sheet 500) disposed in the receiving space may be separated from outside air or other external elements, so that damage due to infiltration of the outside air in the elements described above may be prevented.

The heat dissipating part 300 may prevent heat generated from the light source part 410 from being transmitted to the display panel 100 to deteriorate configurations of pixels and the like of the display panel 100. The heat dissipating part 300 may include a material having a relatively high thermal conductivity. For example, the heat dissipating part 300 may include aluminum and/or graphite. In addition, the heat dissipating part 300 may attach and fix the light source part 410 and the light source part substrate 400 to the display panel 100.

The heat dissipating part 300 may be disposed under the display panel 100. The heat dissipating part 300 may include a first portion 301 which extends parallel with the display panel 100, a second portion 302 extending from the first portion 301 in a direction perpendicular to the display panel 100 and to the first portion 301 (e.g., in a direction opposite to the third direction D3) and a third portion 303 extending from the second portion 302 in parallel with the display panel 100 and the first portion 301. A cross-section of the heat dissipating part 300 may have a shape that is similar to a “C shape”. For example, the heat dissipating part 300 includes an opening. The heat dissipating part 300 may face the light incidence surface 202 of the light guiding plate 200. As an additional example, the opening of the heat dissipating part 300 may face the light incidence surface 202.

The heat dissipating part adhesive member 310 may be disposed between the display panel 100 and the first portion 301 of the heat dissipating part 300, and may attach the first portion 301 of the heat dissipating part 300 to the display panel 100. The heat dissipating part adhesive member 310 may be a double-sided tape such as a foam tape having adhesive layers formed on both surfaces thereof.

The light source part substrate 400 may be disposed in the heat dissipating part 300. The light source part substrate 400 may be an insulation substrate or a flexible insulation substrate. The light source part substrate 400 may include, for example, a metal pattern for driving the light source part 410 formed thereon. The light source part substrate 400 may extend in the second direction D2. For example, a plurality of the light source parts 410 may be arranged along the light source part substrate 400 in the second direction D2.

The light source part 410 is mounted on the light source part substrate 400 and the light source part 410 may include a mold 412 and a light-emitting diode (LED) 414.

The mold 412 may be formed using a resin, and the resin may be, for example, a Polyphtalamide resin(PPA) and/or Polycyclomethylene terephthalate resin(PCT) and the like. The mold 412 may include an opaque material to reflect the light received from the light source part 410.

The LED 414 may be an LED chip (light emitting diode chip) for generating the light. The light from the LED 414 may be incident into the light incidence surface 202 of the light guiding plate 200. The LED 414 may be disposed on the light source part substrate 400 and electrically connected to the metal pattern formed on the light source part substrate 400.

Here, the light source part substrate 400 may be spaced from the first portion 301 of the heat dissipating part 300 and may be in contact with the third portion 303.

The light source part substrate 400 may be spaced from the first portion 301 of the heat dissipating part 300 and may be in contact with the third portion 303. Accordingly, heat generated from the light source part 410 may be transmitted to the third portion 303 of the heat dissipating part 300, which is located farther from the display panel 100 than the first portion 301 is and is in contact with the light source part substrate 400, so that the heat may dissipate to the outside and away from the display panel 100.

The light source part 410 may further include a fluorescent layer or the like disposed on the LED 414 to increase light efficiency.

The light source part adhesive member 420 may be disposed between the light source part substrate 400 and the heat dissipating part 300 to attach the light source part substrate 400 to the heat dissipating part 300. For example, the light source part adhesive member 420 may be disposed between the second portion 302 of the heat dissipating part 300 and the light source part substrate 400. The light source part adhesive member 420 may be a double-sided tape.

The optical sheet 500 may be received in the receiving space formed by the light guiding plate adhesive member 210. For example, the optical sheet 500 may be disposed between the display panel 100 and the light guiding plate 200. The receiving space may be sealed by the light guiding plate adhesive member 210, so that damage due to infiltration of the outside air or other external elements in the elements described above may be prevented.

The optical sheet 500 may increase efficiency of the light from the light guiding plate 200. For example, the optical sheet 500 may make the brightness of the light emitted from the light guiding plate 200 uniform. The optical sheet 500 may include a plurality of optical sheets. For example, the optical sheet 500 may include a protective sheet, a prism sheet, a diffusion sheet, and/or a quantum dot (QD) sheet which includes a quantum dot.

The quantum dot may be a material that has a nano-scaled structure and may include several hundred to several thousand atoms. Since the quantum dot is relatively very small in size, a quantum confinement effect may occur. The quantum confinement effect may indicate that an energy band gap of an object is increased when the object becomes smaller than nano size. When the light having energy higher than that of the band gap is incident to the quantum dot, the quantum dot may absorb the light and may emit a second light having a predetermined wavelength and an energy level in the ground state. The wavelength of the emitted second light may have a value corresponding to the band gap. When a size and a composition of the quantum dot are adjusted, the emission property of the quantum dot may be controlled by the quantum confinement.

The composition of the quantum dots is not limited to a specific composition, and any suitable composition may be used. For example, the quantum dot may be a quantum dot of, for example, Group II-VI elements, Group III-V elements, Group IV elements, or Group IV-VI elements. The Group II elements may include, for example, zinc, cadmium, and/or mercury. The group III elements may include, for example, aluminum, gallium, and/or indium. The Group IV elements may include, for example, silicon, germanium, tin, and/or lead. The Group V elements may include, for example, nitrogen, phosphorus, and/or arsenic. The Group VI elements may include, for example, sulfur, selenium, and/or tellurium.

For example, the QD sheet may include a plurality of light-converting fibers and a polymer layer. Each of the light-converting fibers may include a base fiber and a plurality of the quantum dots embedded in the base fiber. The base fiber may include an inorganic material. The inorganic material may have an optical transparency property.

The light-converting fibers may be laminated while crossing each other to form a network (e.g., a web shape). The light conversion fibers may be formed through an, for example, electrospinning method.

The light-converting fibers may be embedded in the polymer layer. For example, the polymer layer may be disposed to cover the light-converting fibers. The base fibers may be fixed to the polymer layer so that the network shape of the light-converting fibers may be maintained by the polymer layer.

The configuration of the optical sheet 500 is not limited thereto, and may be variously configured.

In an exemplary embodiment of the present inventive concept, instead of the optical sheet 500 including the QD sheet, a QD layer may be formed on the upper surface of the light guiding plate 200 corresponding to the receiving space. The QD layer may include the quantum dot.

According to an exemplary embodiment of the present inventive concept, the display apparatus may include a display panel 100, and a light guiding plate 200 disposed under the display panel 100 and including a light exiting surface 204 which faces the display panel 100 and a light incidence surface 202. The display apparatus may further include a light guiding plate adhesive member 210 disposed between the display panel 100 and the light guiding plate 200 to attach the light guiding plate 200 to the display panel 100, and a heat dissipating part 300 disposed under the display panel 100. The heat dissipating part 300 may include a first portion 301 which extends parallel with the display panel 100, a second portion 302 which extends from the first portion 301 in a direction perpendicular to the display panel 100, and a third portion 303 which extends from the second portion 302 in parallel with the display panel 100 In addition, a cross-section of the heat dissipating part 300 may have a “C shape”, and the heat dissipating part 300 may be disposed to face the light incidence surface 202. The display apparatus may additionally include a heat dissipating part adhesive member 310 disposed between the display panel 100 and the first portion 301 of the heat dissipating part 300 to attach the first portion 301 of the heat dissipating part 300 to the display panel 100, and a light source part 410 disposed in the heat dissipating part 300 to provide light to the light incidence surface 202 of the light guiding plate 200.

Accordingly, the heat generated from the light source part 410 may be discharged through the heat dissipating part 300 to prevent the heat from being transmitted to the display panel 100 which may deteriorate the elements of the pixels and the like of the display panel 100.

Here, the light source part substrate 400 on which the light source part 410 is mounted may be spaced apart from the first portion 301 of the heat dissipating part 300 and may be in contact with the third portion 303. Accordingly, heat generated from the light source part 410 may be transmitted to the third portion 303 of the heat dissipating part 300, which is located farther from the display panel 100 and is in contact with the light source part substrate 400, so that the heat may dissipate to the outside.

In addition, the display panel 100 and the light source part 410, which may be, for example, a backlight assembly, and the light guiding plate 200 may be fixed to each other without an additional container or housing. Accordingly, the display apparatus may be easy to handle, and its thickness and size may be reduced.

In addition, a receiving space formed by the light guiding plate adhesive member 210, the display panel 100, and the light guiding plate 200 may be sealed to outside by a light guiding plate adhesive member 210, so that damage due to infiltration of the outside air or other external elements in elements or components disposed in the receiving space (for example, an optical sheet 500) may be prevented.

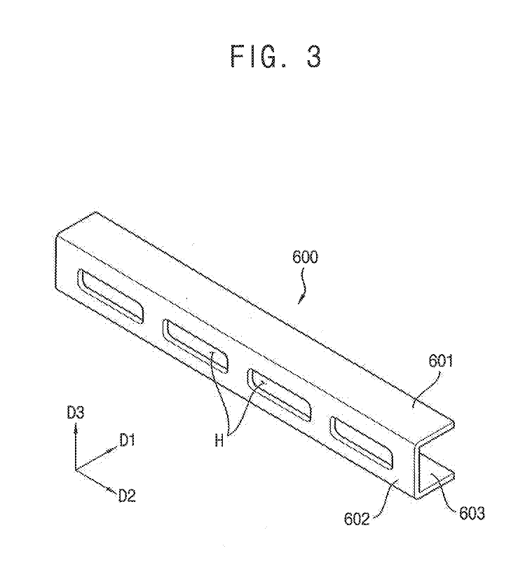

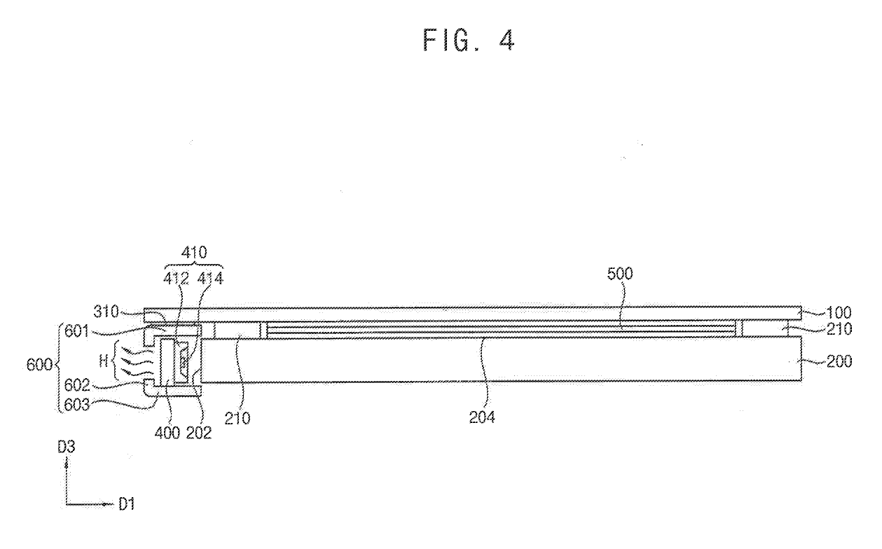

FIG. 3 is a perspective view illustrating a heat dissipating part of a display apparatus according to an exemplary embodiment of the present inventive concept. FIG. 4 is a cross-sectional view illustrating the display apparatus of FIG. 3 according to an exemplary embodiment of the present inventive concept. The display apparatus may be substantially the same as the display apparatus of FIGS. 1 and 2, except for a shape of a heat dissipating part 600. Therefore, to the extent that the description of various elements may be omitted, it may be assumed that these omitted elements are at least similar to corresponding elements that have already been described.

Referring to FIGS. 3 and 4, the heat dissipating part 600 of the display apparatus may include a first portion 601 which extends parallel with a display panel 100, a second portion 602 extending from the first portion 601 in a direction perpendicular to the display panel 100 and the first portion 601 (e.g., in a direction opposite to a third direction D3) and a third portion 603 extending from the second portion 302 in parallel with the display panel 100, and a cross-section of the heat dissipating part 600 may have a “C shape”. The heat dissipating part 600 may face a light incidence surface 202 of a light guiding plate 200.

A plurality of openings H may be formed in the second portion 602. Each opening H may be a heat sink hole for allowing heat generated from the light source part 410 to be emitted through the air along a first direction D1 (e.g., in a direction opposite to a first direction D1). A plurality of the openings H may be formed along the second direction D2 in which the second portion 602 extends. Although four openings are shown in FIG. 3 along the second direction D2, the number and position of the openings H is not limited thereto. For example, the number and position of the openings H may be variously changed.

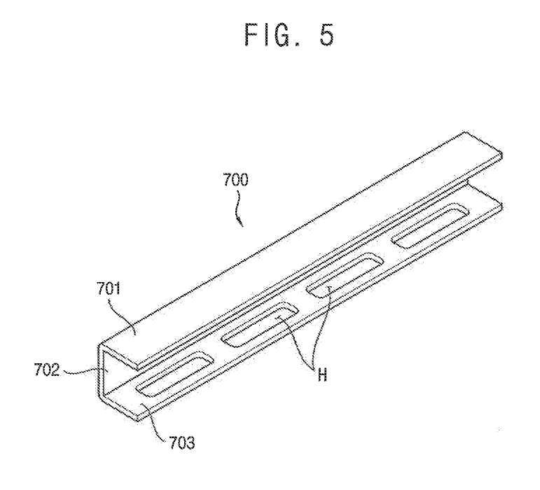

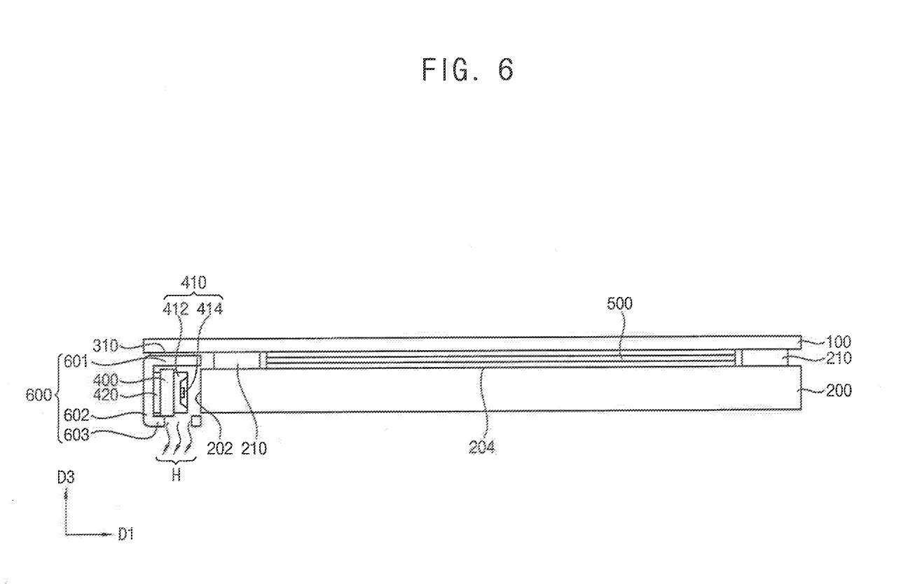

FIG. 5 is a perspective view illustrating a heat dissipating part of a display apparatus according to an exemplary embodiment of the present inventive concept. FIG. 6 is a cross-sectional view illustrating the display apparatus of FIG. 5 according to an exemplary embodiment of the present inventive concept. The display apparatus may be substantially the same as the display apparatuses of FIGS. 1 and 2, except for a shape of the heat dissipating part 700. Therefore, to the extent that the description of various elements may be omitted, it may be assumed that these omitted elements are at least similar to corresponding elements that have already been described.

Referring to FIGS. 5 and 6, the heat dissipating part 700 of the display apparatus may include a first portion 701 which extends parallel with a display panel 100, a second portion 702 extending from the first portion 701 in a direction perpendicular to the display panel 100 and the first portion 701 (e.g., in a direction opposite to a third direction D3) and a third portion 703 extending from the second portion 702 in parallel with the display panel 100, and a cross-section of the heat dissipating part 700 may have a “C shape”. The heat dissipating part 700 may face a light incidence surface 202 of a light guiding plate 200.

A plurality of openings H may be formed in the third portion 703. Each opening H may be a heat sink hole for allowing heat generated from the light source part 210 to be emitted through the air along a first direction D1 (e.g., in a direction opposite to the third direction D3). A plurality of the openings H may be formed along the second direction D2 in which the third portion 703 extends. Although four openings are shown in FIG. 5 along the second direction D2, the number and position of the openings H is not limited thereto. For example, the number and position of the openings H may be variously changed.

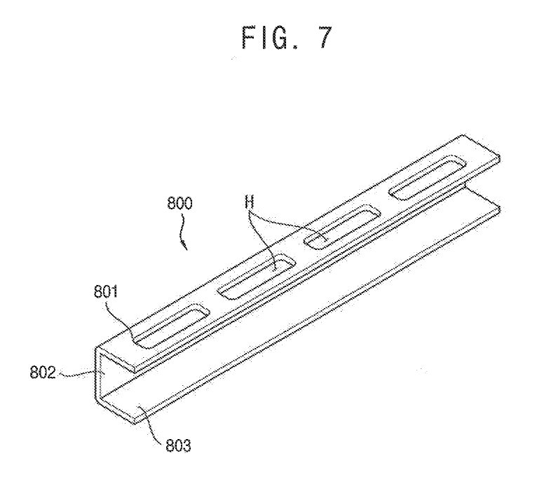

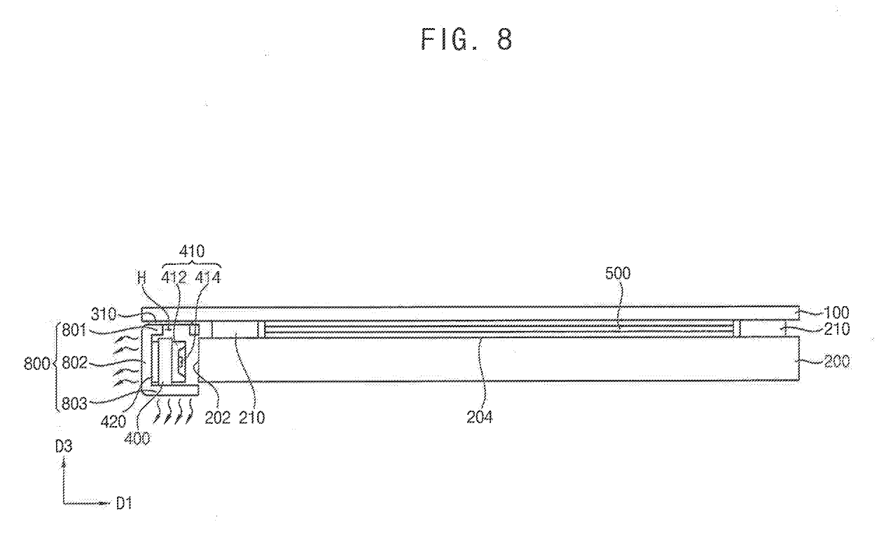

FIG. 7 is a perspective view illustrating a heat dissipating part of a display apparatus according to an exemplary embodiment of the present inventive concept. FIG. 8 is a cross-sectional view illustrating the display apparatus of FIG. 7 according to an exemplary embodiment of the present inventive concept.

The display apparatus may be substantially the same as the display apparatuses of FIGS. 1 and 2, except for a shape of the heat dissipating unit 800. Therefore, to the extent that the description of various elements may be omitted, it may be assumed that these omitted elements are at least similar to corresponding elements that have already been described.

Referring to FIGS. 7 and 8, the heat dissipating part 800 of the display apparatus may include a first portion 801 which extends parallel with a display panel 100, a second portion 802 extending from the first portion 801 in a direction perpendicular to the display panel 100 and the first portion 801 (e.g., in a direction opposite to a third direction D3) and a third portion 803 extending from the second portion 802 in parallel with the display panel 100, and a cross-section of the heat dissipating part 800 may have a “C shape”. The heat dissipating part 800 may face a light incidence surface 202 of a light guiding plate 200.

A plurality of openings H may be formed in the first portion 801. the plurality of the openings H may be formed along the second direction D2 in which the first portion 801 extends. Although four openings are shown in the FIG. 7 along the second direction D2, the number and position of the openings H is not limited thereto. For example, the number and position of the openings H may be variously changed.

Since the openings H are formed in the first portion 801, an area of the heat dissipating part 800 contacting the display panel 100 through the heat dissipating part adhesive member 310 may be reduced. Accordingly, heat conducted to the display panel 100 through the heat dissipating part 800 may be minimized, and the heat may be emitted through the second portion 802 and the third portion 803 of the heat dissipating part 800.

In an exemplary embodiment of the present inventive concept, the heat dissipating part 800 may include a plurality of openings H in the first portion 801 and in the second portion 802 and/or the third portion 803.

According to an exemplary embodiment of the present inventive concept, the display apparatus includes a display panel, and a light guiding plate disposed under the display panel, and including a light exiting surface which faces the display panel and a light incidence surface. The display apparatus further includes a light guiding plate adhesive member disposed between the display panel and the light guiding plate to attach the light guiding plate to the display panel, and a heat dissipating part disposed under the display panel. The heat dissipating part includes a first portion which is parallel with the display panel, a second portion which extends from the first portion in a direction perpendicular to the display panel, and a third portion which extends from the second portion in parallel with the display panel, so that a cross-section of the heat dissipating part has a “C shape”, and the heat dissipating part is disposed to face the light incidence surface. The display apparatus additionally includes a heat dissipating part adhesive member disposed between the display panel and the first portion of the heat dissipating part to attach the first portion of the heat dissipating part to the display panel, and a light source part disposed in the heat dissipating part to provide light to the light incidence surface of the light guiding plate.

Accordingly, the heat generated from the light source part may be discharged through the heat dissipating part 300 to prevent the heat from being transmitted to the display panel to deteriorate pixels and the like of the display panel.

Here, the light source part substrate on which the light source part is mounted may be spaced apart from the first portion of the heat dissipating part and may be in contact with the third portion of the heat dissipating part. Accordingly, heat generated from the light source part may be transmitted to the third portion of the heat dissipating part, which is located farther from the display panel and is in contact with the light source part substrate, so that the heat may dissipate to the outside and away from the display panel.

In addition, the display panel and the light source part, as the backlight assembly, and the light guiding plate may be fixed to each other without an additional container or housing. Accordingly, the display apparatus may be easy to handle, and its thickness may be reduced.

In addition, a receiving space formed by the light guiding plate adhesive member, the display panel, and the light guiding plate may be sealed to outside by a light guiding plate adhesive member, so that damage due to infiltration of the outside air or other external elements in elements or components (for example, an optical sheet) of the display apparatus may be prevented.

In addition, an opening may be formed in the first portion, the second portion and/or the third portion of the heat dissipating part of the display apparatus. Thus, the heat transmitted to the display panel can be reduced.

While the present inventive concept has been described with reference to exemplary embodiments thereof, it will be understood by those of ordinary skill in the art that various changes in form and details may be made thereto without departing from the spirit and scope of the present inventive concept as defined by the following claims.

What is claimed is:

1. A display apparatus, comprising:
a display panel;
a light guiding plate disposed under the display panel, and comprising a light exiting surface and a light incidence surface, wherein the light exiting surface faces the display panel;
a first adhesive member disposed between the display panel and the light guiding plate;
a heat dissipating part disposed under the display panel, and comprising a first portion extending parallel with the display panel, a second portion extending from the first portion in a direction perpendicular to the first portion, and a third portion extending from the second portion and parallel with the first portion, wherein the heat dissipating part faces the light incidence surface;
a second adhesive member disposed between the display panel and the first portion of the heat dissipating part; and
a first light source part disposed in the heat dissipating part and configured to provide light to the light incidence surface of the light guiding plate.

2. The display apparatus of claim 1, further comprising:
a substrate, wherein the first light source part is mounted on the substrate; and
a third adhesive member disposed between the substrate and the second portion of the heat dissipating part.

3. The display apparatus of claim 2, wherein the substrate is spaced apart from the first portion, and makes contact with the third portion.

4. The display apparatus of claim 3, wherein the first light source part comprises a light-emitting diode (LED) and a mold disposed on the substrate, wherein the LED is disposed on the mold.

5. The display apparatus of claim 4, wherein the substrate extends parallel to the first portion, and the display apparatus further comprises a second light source part disposed on the substrate.

6. The display apparatus of claim 5, wherein the light guiding plate is adjacent to the heat dissipating part.

7. The display apparatus of claim 1, wherein the first adhesive member is disposed along an edge of the light exiting surface of the light guiding plate, and the light exiting surface of the light guiding plate, a lower surface of the display panel and the first adhesive member form a receiving space.

8. The display apparatus of claim 7, wherein the receiving space is sealed by the first adhesive member.

9. The display apparatus of claim 7, further comprising:
an optical sheet disposed in the receiving space.

10. The display apparatus of claim 9, wherein the optical sheet comprises a quantum dot (QD) sheet.

11. The display apparatus of claim 8, wherein a quantum dot (QD) layer is disposed on an upper surface of the light guiding plate.

12. The display apparatus of claim 7, wherein the first adhesive member includes a foam tape having adhesive layers formed on both surfaces thereof.

13. The display apparatus of claim 1, wherein the heat dissipating part includes aluminum or graphite.

14. The display apparatus of claim 1, wherein an opening is formed in the second portion.

15. The display apparatus of claim 1, wherein an opening is formed in the third portion.

16. The display apparatus of claim 1, wherein an opening is formed in the first portion.

17. The display apparatus of claim 1, wherein the second adhesive member is a double-sided tape.

18. A display apparatus, comprising:
a display panel;
a light guiding plate disposed on the display panel, and comprising a light exiting surface facing the display panel and a light incidence surface;
a first adhesive member disposed between the display panel and the light guiding plate;
a heat dissipating part disposed on the display panel;
a second adhesive member disposed between the display panel and a first portion of the heat dissipating part;
a substrate disposed on the heat dissipating part;
a light source part disposed on the substrate and configured to provide light to the light incidence surface of the light guiding plate; and
a third adhesive member disposed between the light source part substrate and the heat dissipating part.

19. A display apparatus, comprising:
a display panel;
a light guiding plate disposed on the display panel, the light guiding plate comprising a light exiting surface, which faces the display panel, and a light incidence surface, which faces away from the display panel;
a heat dissipating part disposed under the display panel, and comprising a first portion parallel to the display panel, a second portion extending from the first portion in a direction perpendicular to the first portion, and a third portion extending from the second portion and parallel to the first portion, wherein the heat dissipating part faces the light incidence surface, and at least one of the first portion, second portion or third portion includes a plurality of openings; and
a first light source part disposed in the heat dissipating part and configured to provide light to the light incidence surface of the light guiding plate.

20. The display apparatus of claim 19, wherein the second portion includes the plurality of openings.
